(19) United States
(12) Patent Application Publication
(10) Pub. No.: US 2019/0287036 A1
(43) Pub. Date: Sep. 19, 2019

(54) INTEGRITY RISK MANAGEMENT SYSTEM AND METHOD

(71) Applicant: CORETHIX HOLDINGS PTY LIMITED, Summer Hill (NSW) (AU)

(72) Inventors: ERIC SCHWANTLER, ROZELLE (AU); CHRISTOPHER CROWE, CASTLE HILL (AU); PAUL DAVIS, FOREST LODGE (AU); DARREN MURPHY, NORTH TURRAMURRA (AU); JOHN ROSS, YARRAWARRAH (AU)

(21) Appl. No.: 16/353,486

(22) Filed: Mar. 14, 2019

(30) Foreign Application Priority Data
Mar. 16, 2018 (AU) 2018900871

(51) Int. Cl. G06Q 10/06; G06Q 50/20

(52) U.S. Cl. CPC G06Q 10/0635; G06Q 10/06395; G06Q 50/2057

(57) ABSTRACT

The present invention relates to an online, centralised and fully integrated integrity risk management System that provides businesses with a 360-degree view of their employees to allow the business to effectively manage their integrity related risks. It does this by providing employees with access to a number of integrity based modules that enable the business to, at one end, drive legislative and regulatory compliance through to improving and enhancing employee engagement and understanding of the businesses goals and objectives. The integrity based modules include a library of up to date legislative and company values compliant policies which can be customised as required and linked to accompanying videos to explain the policies, and to also provide an automated survey of the employees to validate their understanding of the policies, and to also provide their employees with a method to register and seek approval for any gifts or entertainment that they have received and any actual or potential conflicts of interest they may have, and to also provide their employees with a method to anonymously report any integrity or other issues that they have witnessed, and to also provide their employees with a method to submit details of any workplace incidents that they have experienced, and to also allow the publishing of key messages and announcements, and to also create a dynamic reporting dashboard which will provide the directors and management of the company with up to date details of the version status of each policy, which policies need to be checked for compliance, which employees have downloaded the policies, which employees have viewed the videos, the results of the questionnaire surveys that have been sent to each employee and the status of any reports received regarding integrity or other issues, all of which are integrated into the integrity risk management System which can stand alone or be incorporated into other software solutions.

### FIELD OF THE INVENTION

The present invention provides for systems and methods for the provision of a fully integrated online integrity risk management system and method for operating a business.

### BACKGROUND OF THE INVENTION

Any discussion of the background art throughout the specification should in no way be considered as an admission that such art is widely known or forms part of common general knowledge in the field.

All businesses are subject to the risk of their employees being involved in actions which are in breach of current legislative or regulatory obligations, contrary to the organisations stated values, policies, and objectives or at odds with accepted standards and practices for their industry and the broader community. Such actions by their employees can cause significant harm to a business including potential legal action against the company and its management and directors, significant financial loss and damage to their brand and reputation and, importantly, be harmful to the welfare of employees and the morale of the organisation. To help protect against these risks, businesses need to ensure that they are compliant with their legal and regulatory obligations and have effective policies and procedures in place that align with the organisations values, goals and objectives and that employees understand and adhere to.

Many businesses have not developed integrity risk management policies or have not kept their policies up to date with current legislative requirements or have not provided a simple method for their employees to view those policies and therefore their employees may not be aware of what is or is not acceptable behaviour in the workplace.

Many businesses use policies to set out their expectations of standards and behaviour for their employees. These policies provide clear direction for the organisation and its employees to operate under and act to enforce those standards of behaviour where required.

Many businesses have policies that can often be overly prescriptive, inconsistent in both their intent and format and at times difficult for their employees to both locate and understand.

Many businesses do not routinely update their policies to ensure that they are current and match the strategic direction of the organisation or current legislative requirements.

Many businesses do not centrally manage their policies. They are managed at a department or business unit level which makes it difficult to drive consistency, manage version control and ensure all policies are up to date and in effect across the entire business.

Many businesses operate internal intranet sites which often have multiple versions and copies of both existing and old policies on their sites. This makes it difficult for employees to readily locate the latest policy and to be confident of their obligations thereunder.

Many businesses do not have an intranet site and so therefore cannot provide their employees with online accessibility to view their policies. Additionally, many businesses do not provide their employees with mobile accessibility to their policies so that they can be accessed whilst away from the organisation.

Many businesses do not have the ability to centrally ensure that their employees have read the company's policies or fully understand the content of those policies. Additionally, many businesses do not have the ability to drive ongoing understanding, awareness, and compliance of their policies by employees to reduce the negative impacts non-adherence can cause to a business.

Many businesses have not provided videos that help their employees to understand the key elements of each of the company's policies.

Many businesses have not implemented a centralised System whereby their employees can declare any actual or potential conflicts of interest that may arise or be perceived, and from which the declaration can be centrally managed with oversight by the appropriate leaders in the business.

Many businesses have not implemented a centralised system whereby their employees can declare workplace incidents which require reporting such as workplace health and safety issues, and from which the declaration can be centrally managed with oversight by the appropriate leaders in the business.

Many businesses have not provided their employees with a system to be able to anonymously report on any action that they witness in the workplace that may be contrary to the company's policies.

Many businesses do not have appropriate whistleblower systems, processes, and protections in place to allow employees to safely and securely report on workplace related issues.

Some businesses understand that by fully implementing a fully integrated Integrity Risk Management System they can create a more inclusive and constructive culture within their organisation.

Many employees who want to access their company's policies want them to be easily accessible and able to be downloaded and read on either PC, MAC, smart phone, or tablet devices.

Many employees who would want to report on any inappropriate actions in the workplace, would want to do so by PC, MAC, smart phone, or tablet devices and would want to do so anonymously and to be confident they will be protected as part of the reporting process.

Some businesses do not have the ability to research and obtain insights on integrity risk management data from other businesses across industries and markets.

### SUMMARY OF THE INVENTION

It is an object of the invention, in its preferred form to provide for an integrated online integrity risk management system and method for operating a business.

In accordance with a first aspect of the present invention, there is provided an online integrated integrity risk management system for use by a series of users and including a series of interacting modules including: a library module including legislative and company values compliant policies and associated linked videos to explain the policies, an automated survey module for surveying users to validate their understanding of the policies, a registers module for users to register and seek approval for any gifts or entertainment that they have received and to notify the system of any actual or potential conflicts of interest they may have; an incident reporting module for users to report any integrity or other issues that they have witnessed, or to submit details of any workplace incidents that they have experienced; an announcements module, for the publishing of key messages and announcements, a dynamic reporting dashboard module providing the operator of the system with the current status of each policy, which policies need to be checked for compliance, which users have downloaded the policies, which users have viewed the videos, the results of the questionnaire surveys that have been sent to each user and the status of any reports received regarding integrity or other issues.

The dynamic reporting dashboard module preferably can include a centralised analytics and business data repository from which the users can obtain integrity risk management related data in order to use the data for insights and to improve business decision making and education and training

The dynamic reporting dashboard preferably can include a centralised analytics and business data repository from which the users can have access to integrity risk management related data from every business which uses the system.

In accordance with a further aspect of the present invention, there is provided an integrity risk management system for managing the integrity risks of a group of users, the system including a number of interactive modules that enable the system to drive legislative and regulatory compliance through to improving and enhancing users engagement and understanding of the systems goals, the modules including: a library module of up to date legislative and company values compliant policies which can be customised as required and linked to accompanying videos to explain the policies; a survey module to automatically survey users to validate their understanding of the policies; a register module for users to register and seek approval for any gifts or entertainment that they have received and any actual or potential conflicts of interest they may have; an incident reporting module for users to anonymously report any integrity or other issues that they have witnessed, and to also provide users with a method to submit details of any workplace incidents that they have experienced; an announcement module to allow for the publishing of key messages and announcements to users;

Further including: a dynamic reporting dashboard module providing users with up to date details of the version status of each policy, which policies need to be checked for compliance, which users have downloaded the policies, the results of the questionnaire surveys that have been sent to each users.

### BRIEF DESCRIPTION OF THE DRAWINGS

Embodiments of the invention will now be described, by way of example only, with reference to the accompanying drawings in which:

FIG. 1 is a schematic drawing of the System showing the centralised modules and of how the System provides a fully interconnected and integrated integrity risk management platform with the System data able to be viewed and analysed in a centralised dashboard.

FIG. 2 is a schematic drawing showing how a business signs up to become a customer of the System.

FIG. 3 is a schematic drawing showing how a customer of the System can set up their company details and add users.

FIG. 4 is a schematic drawing showing how an administrator can select and configure the policies in the System.

FIG. 5 is a schematic drawing showing the process for a user to access and view the policies and videos in the System.

FIG. 6 is a schematic drawing showing the process for an administrator to set up the Surveys in the System and for a user to complete a survey.

FIG. 7 is a schematic drawing showing the process for an administrator to set up the gift and entertainment register in the System and for a user to record gifts and incentives in the register.

FIG. 8 is a schematic drawing showing the process for an administrator to select videos and assign those videos to a specific policy within the System.

FIG. 9 is a schematic diagram showing the process for an administrator to configure the incident reporting categories in the system and for a user to record an incident report.

FIG. 10 is a schematic drawing showing the process for an administrator to set up the speak up reporting option for the System.

FIG. 11 is a schematic drawing showing the set up and configuration process for the dynamic reporting dashboard.

### DETAILED DESCRIPTION

The embodiments of the invention relate to an online, centralised and fully integrated integrity risk management system that provides businesses with a 360-degree view of their employees to allow the business to effectively manage their integrity related risks. It does this by providing employees with access to a number of integrity based modules that enable the business to, at one end, drive legislative and regulatory compliance through to improving and enhancing employee engagement and understanding of the businesses goals and objectives. The integrity based modules include a library of up to date legislative and company values compliant policies which can be customised as required and linked to accompanying videos to explain the policies, and to also provide an automated survey of the employees to validate their understanding of the policies, and to also provide their employees with a method to register and seek approval for any gifts or entertainment that they have received and any actual or potential conflicts of interest they may have, and to also provide their employees with a method to anonymously report any integrity or other issues that they have witnessed, and to also provide their employees with a method to submit details of any workplace incidents that they have experienced, and to also allow the publishing of key messages and announcements, and to also create a dynamic reporting dashboard which will provide the directors and management of the company with up to date details of the version status of each policy, which policies need to be checked for compliance, which employees have downloaded the policies, which employees have viewed the videos, the results of the questionnaire surveys that have been sent to each employee and the status of any reports received regarding integrity or other issues, all of which are integrated into the integrity risk management System which can stand alone or be incorporated into other software solutions.

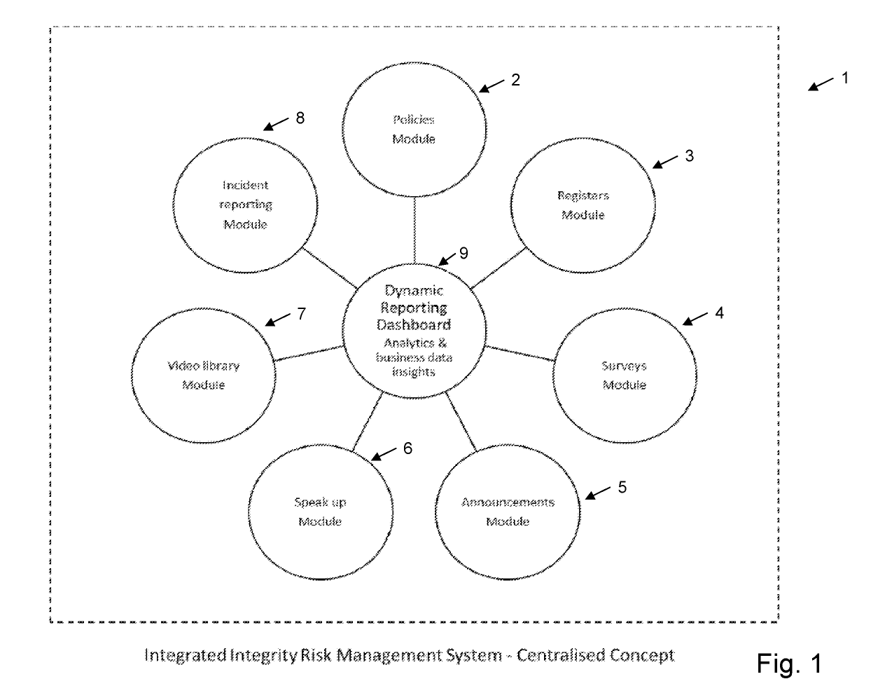

Turning initially to FIG. 1, the embodiments rely on a software server architecture designed to run in a server environment and including a number of substantially independent software modules, which together make up a fully integrated centralised integrity risk management platform or System including; (a) a policy library module, (b) a manual and automated survey tool module to monitor whether employees have read and understood the policies, (c) a video library module, (d) a register system module for employees to register and seek review and approval of gifts and entertainment and actual or potential conflicts of interest, (e) an incident reporting module or System for employees to record workplace related issues such as workplace health and safety, (f) an anonymous speak up module for employees to report any inappropriate workplace actions, (g) a message library module for key messages and announcements, and (h) a customisable dynamic management dashboard reporting tool module.

The overall System 1 provides for integrated integrity risk management platform System.

The policy module 2 provides the user the ability to review the integrity risk management policies either provided as part of the System or uploaded by the users. The policys can include documents and procedures that describe the accepted integrity practices for companies and their employees.

The surveys module 4 refers to the questionnaire survey tool used to measure the employees understanding of the Policies and to gather employee insights. This includes mechanisms for creating and implementing a method to measure employees' knowledge of Policies and procedures.

The Registers module 3 provide a module where employees can record and seek approval for any gifts or entertainment that they have received or declare actual or potential conflicts of interest. This includes mechanisms to monitor, review and manage gifts and entertainment or conflicts of interest.

The Speak Up Module 6 refers to the reporting tool employees and whistleblowers can use to confidentially and anonymously report workplace, and related issues they do not want to report through their manager because they do not feel safe to do so and for which they may wish to request formal whistleblower protection according to local laws and regulation.

The incident reporting module 8 refers to a module whereby employees can submit reports regarding incidents occurring in the workplace such as workplace health and safety or other related issues. This includes a module to allow employees to submit details of incidents for review by their managers.

The dynamic Reporting Dashboard module 9 refers to the dynamic integrity risk management reporting tool which is fully configurable and included as an integral part of the System. This includes a summary report detailing the important measurements of integrity risk management.

The System provides a means for a business to have access to an integrated library of legislatively compliant Policies and to be able to download and edit those Policies as required. The Business can then upload the edited polices, or any other policies into the System. The business can select which Policies are activated and therefore able to be viewed and downloaded by their employees.

Each Policy can be assigned a date for review and the name of the person responsible to ensure that the review is completed. Prior to the date for review, the System will automatically generate a reminder email to be sent to the nominated reviewer. Any Policy which is not reviewed by the assigned date is noted in the Dynamic Reporting Dashboard 9.

The System provides a means for a business to have access to an integrated library of videos and to be able to add additional video to the library. The business can link the videos to a specific Policy to provide an additional source of education and explanation for each Policy.

The System provides a means for the Business to be able to monitor which employees have viewed each Policy and whether an employee has attested that they have read and understood each policy. The System also provides a means to set up automated survey questionnaires to be completed by their employees to validate their understanding of the Policies. The Business can use the typical survey questions provided in the System or create their own survey questions as well as define the time interval between surveys. When the survey date is reached, the System automatically sends out an email to each employee requesting them to log in and to complete the Policy survey questionnaire. The results of the survey for each employee are available to be reviewed by the business and a summary is included in the Dynamic Reporting Dashboard.

The System provides a centralised data repository from which the business can obtain integrity risk management related data in order to use the data for insights and to improve business decision making and education and training

The System provides a means for a Business to monitor, review and manage gifts and entertainment, conflicts of interest or other incidents declared by employees. Each employee is required to register in the System the details of any gifts or entertainment that they may have received, conflict of interest that may exist or any other incident register set up by the business. The method for registering is via a customisable registration form that can be edited by the Business to assign nominated managers to review and manage the registered gifts and entertainment, conflict of interest or other incident in accordance with the Policies.

The System provides a means for the Business to allow employees to anonymously submit a report identifying any action they witness which is not in accordance with the Policies. The method for reporting is via an optional reporting service provided by the System or via a link to a separate external service.

The system provides a means for the Business to allow employees to submit details of any workplace related incidents that they have experienced or witnessed. The incident reports are reviewed by nominated users for each incident category who are assigned to take the appropriate action.

The System provides a means for the Business to publish messages and key announcements to all employees. The messages and announcements are created and edited in the System by the business or uploaded from external files into the System and the employees receive an alert notification when a new message or announcement is activated.

The System provides a means for a business to record data collected within the System and to configure, analyse and review the data in a dynamic reporting dashboard.

The system provides a central location that is easily accessible by their employees and to have surety that their employees have read and understood those policies and adhere to the stated objectives therein.

The system also includes a centralised module whereby their employees can declare any gifts or entertainment that they may have received, and from which the declaration can be centrally managed in accordance with the businesses policies with oversight by the appropriate leaders in the business.

The system also includes a dynamic reporting tool that can provide a summary dashboard showing whether their policies are up to date or data on whether their employees have viewed their policies and videos or data on whether their employees have attested that they have read and understood the policies or a measurement of their employees' understanding of their policies or the details and status of any gifts or entertainment registered by their employees or the status of any reports submitted by their employees.

The integrity risk management system also includes a means for a business to have an overall measure of the effectiveness of an integrity risk program by analysing the multiple elements and employee engagement data of their program and performing a calculation within the dynamic reporting dashboard database using an algorithm that compares this data to industry best practice and outputting a value which is the measure of the effectiveness of the integrity risk program. This calculation is undertaken within the database each month to provide the business with ongoing feedback of the effectiveness of their integrity risk programs and can be used as a guide to improve compliance and employee engagement.

### Further Detailed Description of the Embodiments

An embodiment of the System provides a means for a business to register as a customer of the System. The email, name, address, main contact details and referral code (if obtained by the business as part of the advertising process), are provided by the business. The business is then required to provide credit card details or optionally a company purchase order to pay for the subscription which allows the business to have access to use the System for the subscription period. The System provides a means for a business to set up, configure and modify the System. The System provides a means for a business to select the title name of the System that will be visible to the users.

The System provides a means for a business to install a list of users who will have access to the System. The minimal information required for each user on the list is an email address, a first name and a last name. Optionally the business can supply the division, location, and any other relevant sub-grouping for the users. An email, or other notification, is automatically generated and then sent on behalf of the business to each of the users. The user is then required to log in to the System using their email address, or other identification data, and the temporary password provided in the automatically generated email The System records whether each user has successfully logged on to the System.

The System provides that a business can nominate selected users to be administrators of the System. Administrators have rights within the System to monitor the activity of all the users, utilise the configuration and editing options of the System and configure and view the dynamic reporting dashboard.

The System provides that the administrators have the option to download and modify the policies supplied with the System and then upload the modified policies back into the System. The administrators can also upload any other policies they choose into the System. For each policy uploaded into the System, the administrators are required to insert the date that the policy is due for review. An administrator, or user, is selected to be responsible for the review and updating of each policy and the System monitors the policy review dates and advises the responsible administrator, in advance, that a policy is due for review. The System monitors the status of the policy review dates and reports these details in the dynamic reporting dashboard.

The System provides that the administrators can select and activate which policies are able to be downloaded and viewed by the users. Once the user has read and understood a policy, they are required to acknowledge this in the System. The status of whether a policy has been acknowledged is seen by the user as a highlighted symbol next to the policy. The status and date that a user downloads a policy and acknowledges reading and understanding the policy is recorded in the System.

The System allows for policy updates in line with legislative requirements or best practice to be uploaded into the System for administrators to download and add to their policy in order to keep their business' policies up to date.

The System provides that the administrators can select and make active videos supplied within the System or insert a link and make active any video and link the video to a specific policy or policies. When a video is linked to a policy, then this is seen by the user as a highlighted symbol next to the policy. When the user selects a link to a video it is recorded in the System.

The System provides that the administrators can select and make active policy knowledge surveys that are supplied within the System or modify the supplied surveys or create new surveys within the System. All surveys have an associated release date and frequency that is inserted by the administrators. When the release date is reached, a message is sent to all users to complete the surveys within a set timeframe. The users complete the surveys after logging in to the System and selecting answers to all the questions in the surveys. The results of the survey for each user are recorded in the System.

The System provides that the administrators can create messages and announcements within the System. Each message or announcement can be selected as active by the administrators. When a message or announcement is selected as active, a notification is sent to all users advising them that there is a new message or announcement. The users can view the active messages or announcements after logging into the System.

The System provides that the administrators can select and make active an anonymous speak up function. The speak up function can be configured as a connection to an optional reporting service provided by the System or as a link to an external service.

The System provides that the administrators can select and make active an incident reporting function. The incident reporting function can be configured to create categories of incidents and to assign a reviewer for each category.

The System provides a means for businesses to record data in the dynamic reporting dashboard and to configure, view and analyse the data as a dashboard display or as customised reports. The data that is recorded includes, but is not limited to, whether policies are up to date, whether each employee has viewed policies and videos, whether each employee has attested that they have read and understood the policies, a measurement of each employees' understanding of the policies, the details and status of any gifts or entertainment registered by each employee, the status of any reports submitted by each employee and other relevant information.

The system provides a means for a business to have access to integrity risk management related data from every business which uses the System. This allows data to be gathered, in accordance with published terms and conditions and privacy obligations, across different size businesses and industries which can then be sold or released for research.

The System provides that a user can download an app for their mobile device and register as a user.

The System provides that the user is identified by their email address or other unique identification data.

In an alternative embodiment, the System provides for a Business to incorporate the System into another existing software System platform of the Business to create a single software System platform for their users. If this is the case, then the Business will pay a negotiated fee for the use of the System.

In an alternative embodiment, the System provides for a Business to incorporate the System into another existing software System platform of the Business that can marketed and sold to other businesses as a single software System platform. If this is the case, then the Business will pay a negotiated fee for the use of the System.

In an alternative embodiment, the System provides for a Business to resell the System as a software subscription service to other businesses.

FIG. 1 is a schematic diagram showing how the modules 1 of the System are fully integrated and how integrity related data from policies, registers, video library, surveys, speak up, incident reporting and announcements for users is managed centrally and can be analysed and presented in the dynamic reporting dashboard along with business data insights from other businesses and industries.

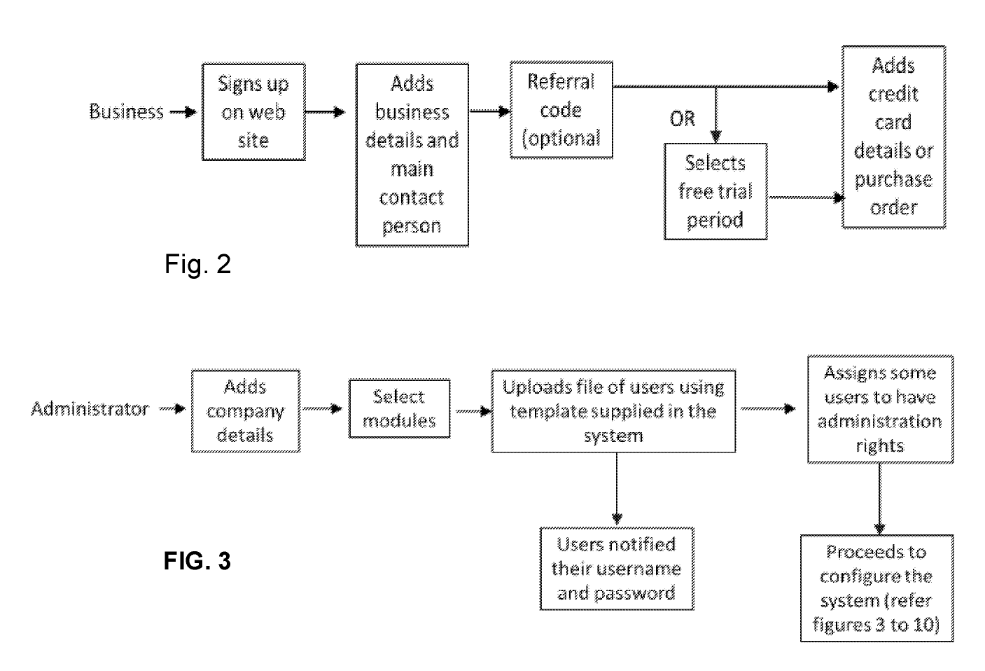

FIG. 2 is a schematic diagram showing a business signing up to the System as a customer. This view shows the business signing up on the System's web site. Firstly, the business adds their email and password or other credentials. The business then supplies their business name, address, phone number and website details plus the name and phone number of the main contact person for the business. The business then has the option to add a referral code that they have received from the System or from another business. The business will then be sent an automatically generated email from the System confirming that the business is registered to use the System. The business may choose to initially use the System for a fixed trial period prior to paying the subscription price for usage or alternatively choose to immediately pay the subscription price. When the business pays the subscription price for the System they are required to enter their credit card details into the System or alternatively they can make a request to the System to use a company purchase order as a means of confirming payment.

In FIG. 3 is a schematic diagram showing the process for the subscribed business to set up their company details and to load the details of their users into the System. The administrator is a user that has been selected by the business with rights to set up, configure and modify the System including selecting which modules are to be used. An administrator has access to the settings view of the System which allows for the set up and configuration for all features of the System. The first role for the administrator is to select the settings view and then to add the company details into the System including the company logo, website address, and the title name for the System that will be visible to the users. The administrator then adds the users, which are company employees, contractors, or anyone else that the administrator believes should have access to the System. The administrator can add the users by downloading and completing a template supplied in the System for all the users that will have access to the System and then uploading the completed template into the System. The users can be sub grouped into company division or company location or other sub grouping options that are included in the System. The administrator can also assign some users to become administrators and have administrator's rights. Once users are added to the System they are sent an automatically generated welcome email that advises them of the details of the System and requests them to log in to the System using their email, or other unique identification data, as the username and a password to be selected by the user. Users can be assigned different permissions depending on their needs or seniority, to allow them to obtain reporting or view specific aspects of the System.

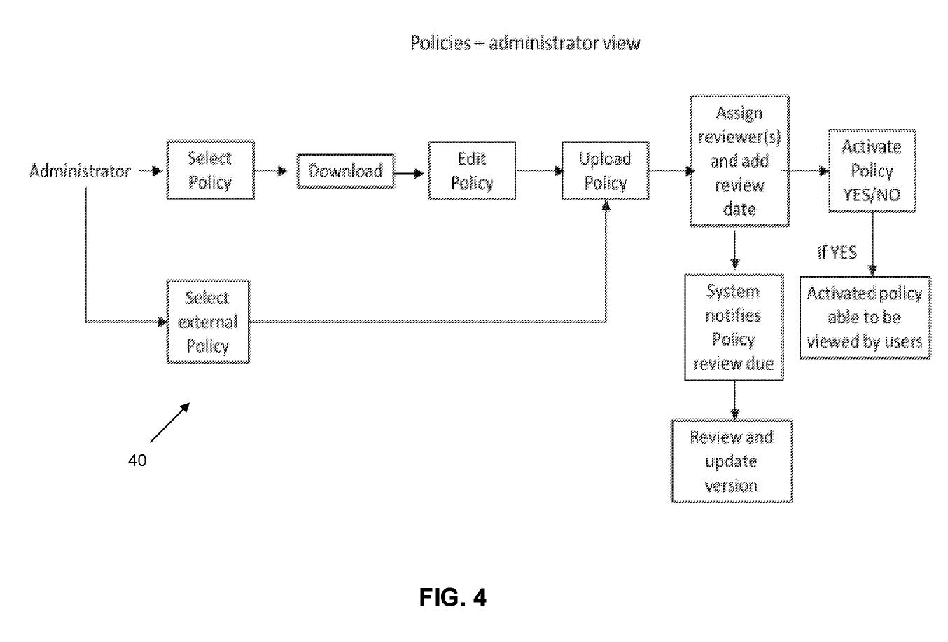

FIG. 4 is a schematic diagram 40 that shows the process for an Administrator to configure the policies in the System and to set up the policy reviewers and dates that the policies will need to be reviewed. In this view it is shown that the administrator firstly selects which policies will be used in the System. The administrator can select from a library of policies that are supplied with the System and then download, edit, and upload those policies back into the System. The administrator can also select and upload any other externally sourced policies that may be applicable for the business. The next step for the administrator is to assign a user to be responsible for the review of each policy along with a date that each policy is required to be reviewed by. The system will notify the administrator when the assigned policy is due for review. The administrator will then review and update the policy. The administrator can then select to activate a policy which allows for that policy to be viewed by all the users.

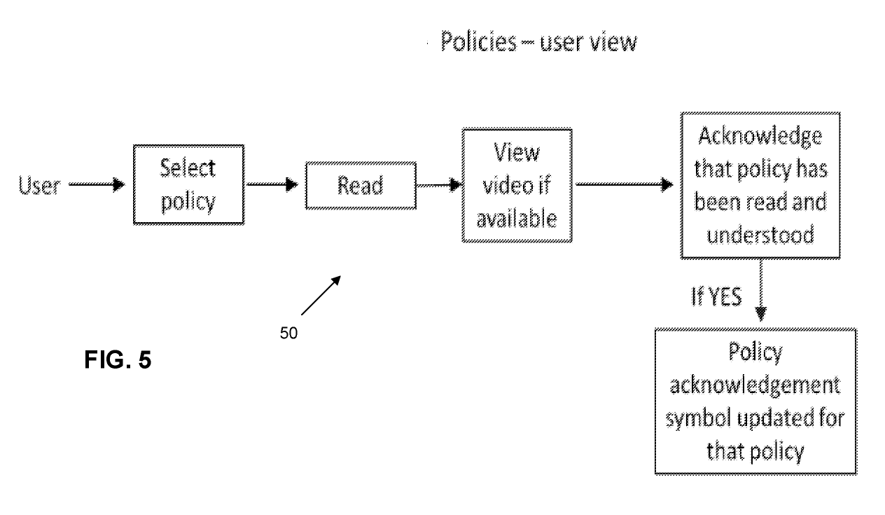

FIG. 5 is a schematic diagram that shows the process 50 for a user to view a policy and to acknowledge that the policy has been read and understood as well as the process for a user to view an associated video for the policy. The first step for the user is to log in to the System and to view the policies that have been made active by the administrator. The user can then select and view the policy so that it can be read either immediately or at a later time. If there is an associated video available for a policy, then the user is advised by a highlighted video symbol displayed next to the policy description in the System. The user can then watch the video by selecting the displayed symbol. Once the user has read and is confident that they understand the policy, they acknowledge this by selecting the policy attestation symbol displayed next to the policy description in the System. Once this symbol is selected, a pop-up message is displayed requesting the user to confirm that they have read and understood the policy. The user confirms this by selecting a tick box in the pop-up message. The pop-up message closes and the image and colour of the attestation symbol changes.

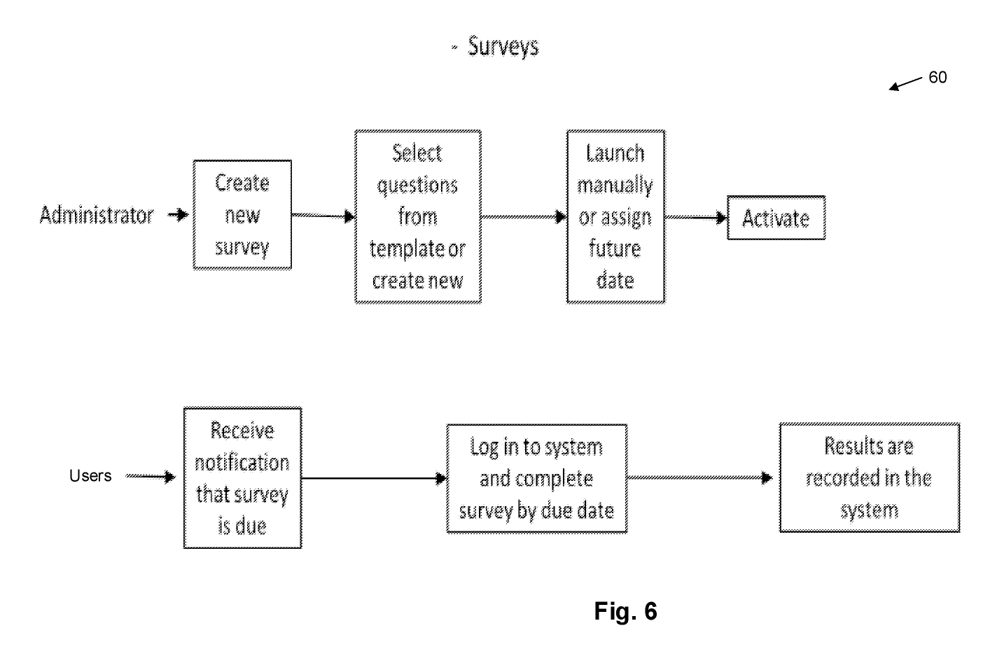

FIG. 6 is a schematic diagram of one form of the present invention that shows the process for an administrator to create and activate surveys and the process for users to complete a survey in the System. The first step for the administrator to create a new survey is to view and modify the included survey questions in the System or to create new survey questions as required. The administrator then assigns a survey launch date for each survey and activates the surveys to be completed by the users. Once surveys have been activated and the launch date reached, a notification is sent by the System to each user advising them to complete the survey. The user is then required to log in to the System and complete the survey by the due date displayed on the survey. The System records data on whether a user has completed the survey as well as the results of the survey for each user.

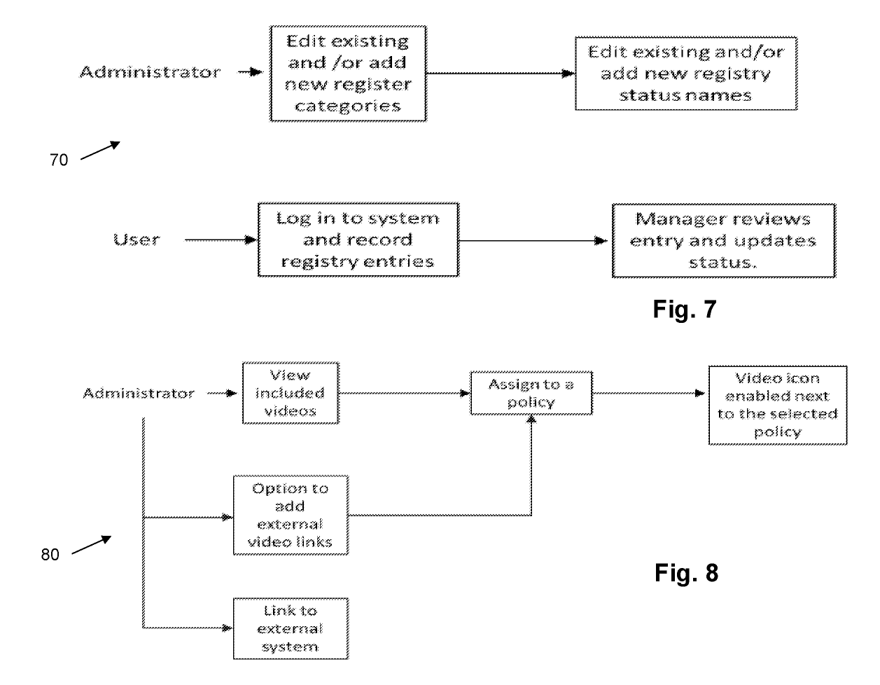

FIG. 7 is a schematic diagram showing the process 70 for an administrator to set up and activate register categories such as gifts and entertainment, conflict of interest, or any other register categories in the System and the process for the user to record entries in the appropriate category. FIG. 7 also shows the review and management process for the registers. The first step for the administrator is to view and modify the included categories in the System or to create new categories as required such as gifts and entertainment, conflicts of interest etc. As shown in the diagram, the process for the user to declare gifts and entertainment, conflicts of interest or other items is to firstly log in to the System and then to select the appropriate category to record the details required. All the register entries made by the users are collated in the System and can be reviewed by the user's manager. The System records the details and review status of each register entry.

FIG. 8 is a schematic diagram showing the process 80 for an administrator to select videos and assign them to a specific policy within the System. As shown in the diagram, the first step for the administrator is to review and select which of the videos included in the System are to be assigned to the policies. The administrator can also access any external videos by adding those video links into the System. The externally sourced videos can also be assigned to the policies. If there is an associated video available for a policy, then the user is advised by a highlighted video icon displayed next to the policy description in the System. The user can then watch the video by selecting the displayed symbol. The administrator also has the option to link the System to an external system for the users to view other video resources.

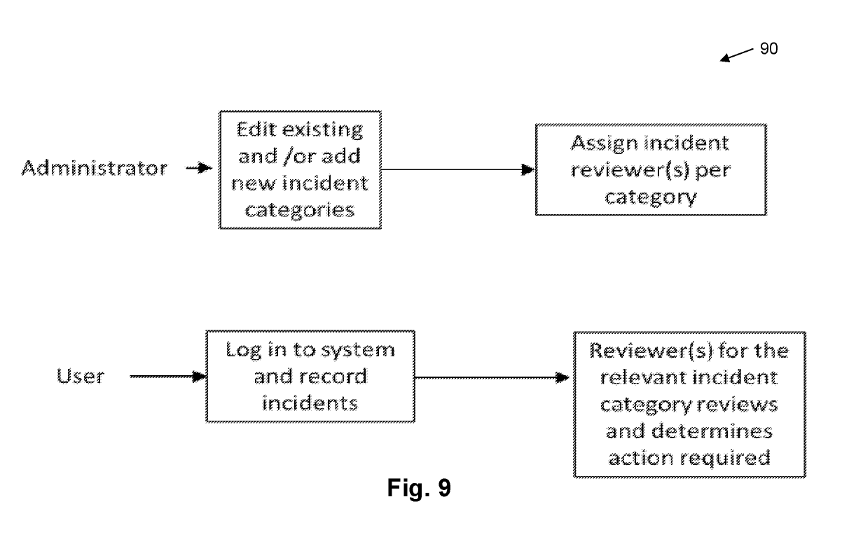

FIG. 9 is a schematic diagram that shows the process 90 for an administrator to set up the incident reporting function for the System. As shown in the diagram, the first step is for the administrator to view and modify the incident categories that are included in the System or to create new incident categories as required, for example health and safety. The administrator then assigns a reviewer for each incident category. As shown in the diagram, the process for the user to report any incident that has occurred is to firstly log in to the System and then to select the appropriate category to record the incident details. All the incident reports made by the users are collated in the System and are reviewed by the assigned reviewer for each incident category. The System records the details and review status of each incident report.

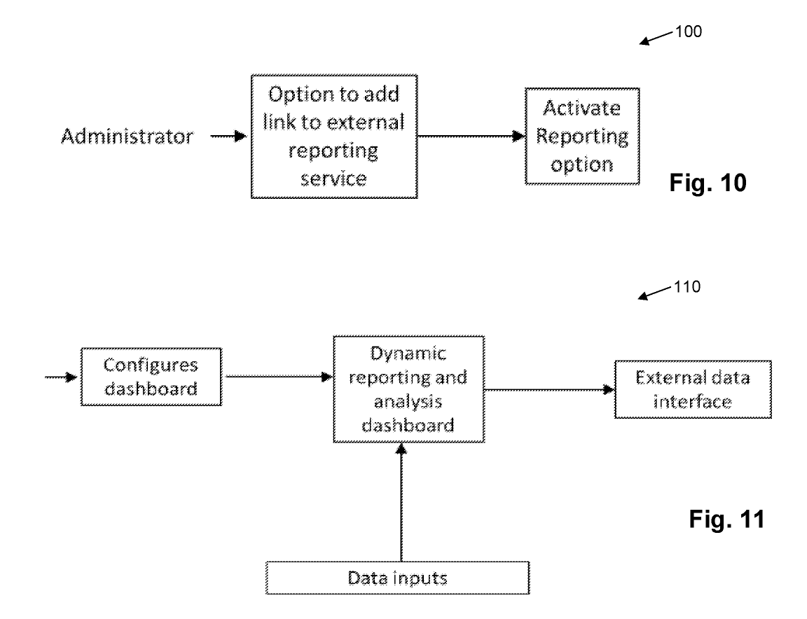

FIG. 10 is a schematic diagram that shows the process 100 for an administrator to set up the speak up option for the System. As shown in the diagram, the first step for the administrator is to select to use an external speak up service. If the administrator selects an external speak up service, then the administrator adds the URL link for that service into the System. The next step for the administrator is to activate the speak up option to make it available to the users. All reports logged by the users are managed confidentially and external to the System and are not able to be viewed by the administrators or other users.

FIG. 11 is a schematic diagram showing 110 the data that is recorded by the System and available to be displayed in the dynamic reporting dashboard and the process for an administrator to configure the dynamic reporting dashboard. As shown in the diagram, the first step for the administrator is to configure the dashboard which is done by selecting the data to be displayed and the visualisation of the data elements of the dashboard. The administrator can select any data that is recorded by the System. This data includes but is not limited to ; (a) the status of whether a user has first logged in to the System (b) policy review status (c) whether a user has downloaded a policy (d) whether a user has viewed a video (e) whether a user has acknowledged reading and understanding a policy (f) the results of policy surveys for each user (g) whether gifts and entertainment, conflicts of interest or other incidents such as workplace health and safety are registered in the System have been reviewed and managed (h) whether a user has read a message or announcement. The administrator can also set up and configure thresholds and parameters to allow detailed analysis of the data. The administrator can then configure the data in the System to be displayed by the divisions, location, or other applicable groupings of users of the Business. The administrator can also configure the data to be displayed on a time base, or as a percentage, or as a graph, or as a pie chart or as any other visualisation displays provided by the System. Once the administrator has completed the configuration process, the data will be published in the dashboard view of the System and made available to external systems if required. The dashboard view is only available to the administrators of the Business.

It can therefore be seen that the embodiment include an online and fully integrated integrity risk management system comprising integrity based modules which comprise a library of up to date legislative and company values compliant policies which can be customised as required and linked to accompanying videos to explain the policies, and to also provide an automated survey of the employees to validate their understanding of the policies, and to also provide their employees with a method to register and seek approval for any gifts or entertainment that they have received and any actual or potential conflicts of interest they may have, and to also provide their employees with a method to anonymously report any integrity or other issues that they have witnessed, and to also provide their employees with a method to submit details of any workplace incidents that they have experienced, and to also allow the publishing of key messages and announcements, and to also comprise a dynamic reporting dashboard which will provide the directors and management of the company with up to date details of the version status of each policy, which policies need to be checked for compliance, which employees have downloaded the policies, which employees have viewed the videos, the results of the questionnaire surveys that have been sent to each employee and the status of any reports received regarding integrity or other issues, all of which are integrated into the integrity risk management system which can stand alone or be incorporated into other software solutions.

The dynamic reporting dashboard can include a centralised analytics and business data repository from which the business can obtain integrity risk management related data in order to use the data for insights and to improve business decision making and education and training The dynamic reporting dashboard can further include a centralised analytics and business data repository from which the business can have access to integrity risk management related data from every business which uses the system.

Integrity Risk Index

The embodiments assist in the creation of an integrity risk index. One form of integrity risk index will now be described. The integrity risk index is a measurement to predict if a company is at future risk of an integrity risk issue. The key elements to consider in formulating this measurement need to be inputted into an algorithm that could accurately calculate a value or index which is the Integrity Risk Index value. To perform this calculation in the software database requires up to date data on the key elements that a company would need to develop a best practice integrity risk program. These comprise the following:

1. A corporate culture in support of an integrity risk program and ongoing communication from the management to remind employees of their responsibilities.

2. Six core policies: Code of Conduct (also called Code of Ethics), Fraud and Corruption, Whistleblower, Conflicts of Interest, Travel, Gifts and Entertainment and Data, Information Technology and Social Media.

Each of these policies needs to be kept up to date and legislatively compliant. Each of these policies needs to be easily accessible by all employees. Each of these policies needs to be read and understood by all employees. Survey questionnaires and employee training should be conducted on a regular basis to check each employees understanding of the policies. An effective process to monitor the Gifts & Entertainment and Conflicts of Interest involving employees should be in place. Definitions of what constituted Gifts & Entertainment, and Conflicts of Interest will need to be defined in the associated company policies. A declaration Register would be required to enable employees to readily input Gifts & Entertainment, and Conflicts of Interest. An approval process would need to be defined for all Gifts & Entertainment, and Conflicts of Interest declared. A monitoring process will need to be developed to manage frequent and excessive declarations.

Variables and Weightings for the Integrity Risk Index Calculation

Each element of a business' integrity risk program is considered as a variable with estimated weighting of the variable based on industry best practice integrity risk practice. The values for the weightings (factor points) are assigned to each of the key variables based on a number of factors such as: A qualitative corporate culture measurement plus the completeness and compliance of the business' policies. Policy surveys and declaration registers plus the measurement of the users' understanding of the policies and procedures plus the measurement of the approval and monitoring of the declarations received.

The total of these values is scaled to 1000 and represents an industry best practice model. Therefore, using the results of the integrity risk index calculation, a business can constantly monitor and compare their own integrity risk program to a best practice scenario. The higher the integrity risk index value for a company, the more the likelihood and impact of an Integrity Risk Incident is reduced. This is a dynamic index where the value changes over time.

The tables below show one form of the weightings and values that are programmed into a software database algorithm for different areas of integrity risk. The weightings can be continually tuned based on industry best practice and legislative changes over time.

1. Assigned values for quantitative measures are shown in the following table.

| Qualitative Measures | Corporate support | Ongoing communications |
|---|---|---|
| Self assessed values (0 to 5) | CS | CC |
| Number of factor | 35 | 35 |
| points attributed | | |

The total factor points for qualitative measures is 70.

2. Assigned values for categories of integrity risk policies published are shown in the following table.

| | | Policy | Policy |
|---|---|---|---|
| Integrity Risk Policies | Policy Issued Y/N | updated Y/N | video Y/N |
| Code of Conduct | PI1 | PU1 | PVid1 |
| Fraud and Corruption | PI2 | PU2 | PVid2 |
| Whistleblower | PI3 | PU3 | PVid3 |
| Gifts & Entertainment | PI4 | PU4 | PVid4 |
| Conflicts of Interest | PI5 | PU5 | PVid5 |
| Data, IT and Social Media | PI6 | PU6 | PVid6 |
| Number of factor points | 15 | 10 | 5 |
| attributed (for each policy) | | | |

The total factor points for integrity risk policies is 180

3. Assigned values for user actions are shown in the following table;

| User actions (as % of total users) | Policy Viewed Y/N | Policy Attested % |
|---|---|---|
| Code of Conduct | PV1 | PA1 |
| Fraud and Corruption | PV2 | PA2 |
| Whistleblower | PV3 | PA3 |
| Gifts & Entertainment | PV4 | PA4 |
| Conflicts of Interest | PV5 | PA5 |
| Data, IT and Social Media | PV6 | PA6 |
| Number of factor points | 15 | 25 |

| | |
|---|---|
| attributed (for each policy) | (where 25 = 100% of users |
| | have attested) |

The total factor points for user actions is 240

4. Assigned values for conducting policy surveys and the results of the surveys are shown in the following table.

| Policy Surveys and results | Survey run annually Y/N | Survey Results % |
|---|---|---|
| Code of Conduct | PS1 | PSurv1 |
| Fraud and Corruption | PS2 | PSurv2 |
| Whistleblower | PS3 | PSurv3 |
| Gifts & Entertainment | PS4 | PSurv4 |
| Conflicts of Interest | PS5 | PSurv5 |
| Data, IT and Social Media | PS6 | PSurv6 |
| Number of factor points | 15 | 50 |

| | |
|---|---|
| attributed (for each policy) | (where 50 = 100% of users |
| | have correctly answered) |

The total factor points for policy surveys and results is 390

5. The assigned values for declarations for gifts and entertainment and conflicts of interest are shown in the following table.

| Declarations | Outstanding approvals % | highest value for a user |
|---|---|---|
| Gifts & | RA | RV |
| Entertainment | | |
| Conflicts of Interest | 60 | 60 |
| Number of factor | | |
| points attributed | | |

The total factor points for declarations is 120

Integrity Risk index Algorithm Formula

Each of these values is inputted into an algorithm within the software database which performs a calculation to produce the integrity risk index for a business. The details of the calculation can be as follows:

a. Total for Corporate Values=CS+CC

b. Integrity Risk Policies

Policy Issued Total—PIT=PI1+PI2+PI3+PI4+PI5+PI6

Policy Updated Total—PUT=PU1+PU2+PU3+PU4+PU5+PU6

Policy Video Total—PVidT=PVid1+PVid2+PVid3+PVid4+PVid5+PVid6

Total for Integrity Risk Policies=PIT+PUT+PVidT

c. User Actions

Policy Viewed Total—PVT=PV1+PV2+PV3+PV4+PV5+PV6

Policy Attested Total—PAT=PA1+PA2+PA3+PA4+PA5+PA6

Total for User Actions=PVT+PAT

d. Policy surveys and Results

Survey Run annually—Total PST=PS1+PS2+PS3+PS4+PS5+PS6

Survey Results Total—PSurvT=PSurv1+PSurv2+PSurv3+PSurv4+PSurv5+PSurv6

Total for Policy Surveys and Results=PST+PSurvT

e. Total For gift and entertainment and conflict of interest Registers=RA+RV

f. Integrity Risk Index=(CS+CC)+(PIT+PUT+PVidT)+(PVT+PAT)+(PST+PSurvT)+(RA+RV)

The result of the calculation is a number between 0 and 1000.

### Interpretation

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. An online integrated integrity risk management system for use by a series of users and including a series of interacting modules including:
a library module including legislative and company values compliant policies and associated linked videos to explain the policies,
an automated survey module for surveying users to validate their understanding of the policies,
a register module for users to register and seek approval for any gifts or entertainment that they have received and to notify the system of any actual or potential conflicts of interest they may have;
an incident reporting module for users to report any integrity or other issues that they have witnessed, or to submit details of any workplace incidents that they have experienced;
an announcements module, for the publishing of key messages and announcements,
a dynamic reporting dashboard module providing the operator of the system with the current status of each policy, which policies need to be checked for compliance, which users have downloaded the policies, which users have viewed the videos, the results of the questionnaire surveys that have been sent to each user and the status of any reports received regarding integrity or other issues.

2. A system as claimed in claim 1 wherein the dynamic reporting dashboard module includes a centralised analytics and business data repository from which the users can obtain integrity risk management related data in order to use the data for insights and to improve business decision making and education and training

3. A system as claimed in claim 1 wherein said dynamic reporting dashboard includes a centralised analytics and business data repository from which the users can have access to integrity risk management related data from every business which uses the system.

4. A system as claimed in claim 1 wherein the system provides an overall single measure of the effectiveness of their integrity risk program by analysing the multiple elements and user engagement data of the modules and performs a calculation using an algorithm that compares this data to industry best practice.

5. An integrity risk management system for managing the integrity risks of a group of users, the system including a number of interactive modules that enable the system to drive legislative and regulatory compliance through to improving and enhancing users engagement and understanding of the systems goals, the modules including:
a library module of up to date legislative and company values compliant policies which can be customised as required and linked to accompanying videos to explain the policies;
a survey module to automatically survey users to validate their understanding of the policies;
a register module for users to register and seek approval for any gifts or entertainment that they have received and any actual or potential conflicts of interest they may have;
an incident reporting module for users to anonymously report any integrity or other issues that they have witnessed, and to also provide users with a method to submit details of any workplace incidents that they have experienced;
an announcement module to allow for the publishing of key messages and announcements to users;

6. A system as claimed in claim 5 further including:
a dynamic reporting dashboard module providing users with up to date details of the version status of each policy, which policies need to be checked for compliance, which users have downloaded the policies, the results of the questionnaire surveys that have been sent to each users.
